(19) United States
(12) Patent Application Publication
(10) Pub. No.: US 2012/0240381 A1
(43) Pub. Date: Sep. 27, 2012

(54) MOLDED CONNECTION JOINT AND/OR HINGE

(75) Inventor: Mark R. Carey, Upper Sandusky, OH (US)

(73) Assignee: CVG MANAGEMENT CORPORATION, New Albany, OH (US)

(21) Appl. No.: 13/348,299

(22) Filed: Jan. 11, 2012

Related U.S. Application Data
(60) Provisional application No. 61/467,134, filed on Mar. 24, 2011.

(51) Int. Cl. F16C 11/04; B23P 11/00; F16B 17/00

(52) U.S. Cl. 29/525.01; 403/364; 403/119; 403/161; 29/428

(57) ABSTRACT

A system that facilitates an interlocked joint without the need for a locking pin is provided. The system includes a first member having multiple first fingers extending in an outward direction from a side of the first member and multiple first openings defined between each of the first fingers. The system further includes a second member having multiple second fingers extending in an outward direction from a side of the second member and multiple second openings defined between each of the second fingers. When the first member mates with the second member the first fingers are aligned with and engage the second openings and the second fingers are aligned with and engage the first openings such that the first member and the second member are interlocked and inseparable in a tensile direction.

### CROSS-REFERENCE TO RELATED APPLICATIONS

This application claims the benefit of U.S. Provisional Patent application Serial No. 61/467,134 entitled MOLDED CONNECTION JOINT AND/OR HINGE, filed on Mar. 24, 2011.

### ORIGIN

The innovation disclosed herein relates to a system having an interlocking joint. More specifically, the innovation relates to an assembly having two molded parts employing interlocking fingers where the two parts are interlocked when rotated to a predetermined angle.

### BACKGROUND

Conventional systems having a rotating or pivotal joint require a locking pin to secure one part to another part. For example, a door hinge assembly requires a locking pin. Specifically, the door hinge assembly has one part typically mounted to a rigid structure and another part mounted to a door. Both parts include circular cross-sectioned cylinders, as viewed from the side, equally spaced on one edge of each part. The circular cross-sectioned cylinders have a rectangular shape as viewed from a top of each part. When the two parts are mated a locking pin is required to secure the two parts together due to the rectangular shape of each cylinder. In other words, due to the shape of the cylinders, the cylinders from one part do not engage the cylinders from the other part in such a manner that the cylinders are self-interlocking. Hence, the presence of the locking pin.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a general construction design that employs interlocking “fingers,” “knuckles” or “tabs” having surfaces that form locking angles as the fingers are rotated to a predetermined angle wither respect to each other. The innovation's unique design provides for relief such that two parts or members can be aligned adjacent to each other and then pushed together. Upon connecting, this action forms an alignment and tensile resistance to separation. This unique alignment and tensile resistance allows and assists the next action of rotation to “lock” the two parts together. Thus, a “fastener-less” joint can be enabled using these portions or “building blocks.”

In accordance with other aspects of the innovation, a system that facilitates an interlocked joint is provided that includes a first member having a plurality of first fingers extending in an outward direction from a side of the first member and a plurality of first openings defined between each of the plurality of first fingers, a second member having a plurality of second fingers extending in an outward direction from a side of the second member and a plurality of second openings defined between each of the plurality of second fingers, wherein when the first member mates with the second member the plurality of first fingers are aligned with and engage the plurality of second openings and the plurality of second fingers are aligned with and engage the plurality of first openings such that the first member and the second member are interlocked and inseparable in a tensile direction.

In accordance with still other aspects of the innovation, when the first member and the second member are rotated with respect to each other to a predetermined angle the first member and the second member are interlocked and inseparable in any direction.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIGS. 1A and 1B, is a top view and a side view of a hinge assembly 10 at a first stage of assembly in accordance with aspects of the innovation.

FIGS. 2A and 2B, is a top view and a side view of the hinge assembly 10 of FIGS. 1A and 1B at a second stage of assembly in accordance with aspects of the innovation.

FIGS. 3A and 3B, is a top view and a side view of the hinge assembly 10 of FIGS. 1A and 1B at a third stage of assembly in accordance with aspects of the innovation.

FIG. 4 illustrates an example flow chart of procedures that facilitate interlocking the hinge assembly of FIGS. 1A and 1B in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

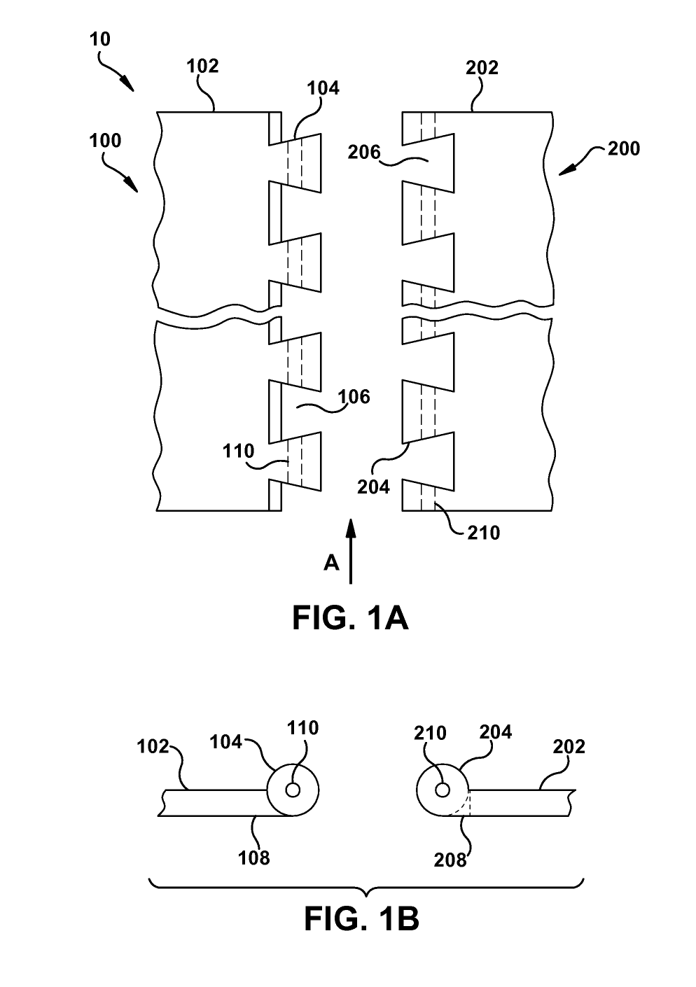

Referring to the drawings, FIGS. 1A, 2A and 3A, and 1B, 2B and 3B are top views and side views respectively of an example embodiment of a system incorporating a self-interlocking joint in accordance with aspects of the innovation. In the example embodiment shown in the figures, the system is comprised of a hinge assembly 10. It is to be appreciated, however, that the overall concept has very broad application including, but not limited to furniture, construction, manufacturing plastics, wood products, metal products, structural elements (e.g., scafolds, fixturing, tube/pipe fittings, etc.) and many other mechanical structure items. Thus, the example embodiment described herein and illustrated in the figures is for illustration purposes only and is not intended to limit the scope of the innovation.

FIGS. 1A and 1B, 2A and 2B, and 3A and 3B show the hinge assembly 10 in three stages (stages 1-3) of assembly respectively in accordance with the innovation. The hinge assembly 10 includes a first part 100 and a second part 200. The first part 100 and the second part 200 mate with each other, as will be described further below, to form the self-interlocking-rotatable joint or connection 300. In other words, the first part 100 and the second part 200 rotate with respect to each other but once rotated they are interlocked in any direction. Essentially, the first and second parts 100, 200 are self-interlocking. As will become evident from the description below, the mateable parts 100, 102 can include parts, surfaces, plates, etc. appropriately angled to allow for moldability and manufacturability with tolerances that enable a tight fit.

Referring to FIGS. 1A and 1B, FIG. 1A is a top view of the hinge assembly 10 and FIG. 1B is a side view taken in the direction of the arrow A shown in FIG. 1A. FIGS. 1A and 1B illustrate the hinge assembly 10 in the first stage of assembly, which is the unassembled state. In the unassembled state (stage 1), the first and second parts 100, 200 are not mated, thus the interlocking joint 300 is not formed.

Referring specifically to FIG. 1A, the first part 100 includes a first member 102, such as but not limited to a plate, multiple first fingers 104 and multiple first openings 106 defined between each of the first fingers 104. The first fingers 104 extend outward from a side or an edge 108 of the first member 102 and have a trapezoidal shape, as viewed from the top or bottom of the first member 102. The extension of the first fingers 104, thus form the first openings 106. It is to be appreciated that the shape of the first fingers 104 does not limit the scope of the innovation. The shape of the first fingers 104 may be any shape, such as but not limited to circular, oval, etc., that facilitates the interlocking feature of the innovation.

Similarly, the second part 200 includes a second member 202, such as but not limited to a plate, multiple second fingers 204 and multiple second openings 206 defined between each of the second fingers 204. The second fingers 204 extend outward from a side or an edge 208 of the second member 202 and have a trapezoidal shape, as viewed from the top or bottom of the second member 202. The extension of the second fingers 204, thus form the second openings 206. It is to be appreciated that the shape of the second fingers 204 does not limit the scope of the innovation. The shape of the second fingers 204 may be any shape, such as but not limited to circular, oval, etc., that facilitates the interlocking feature of the innovation.

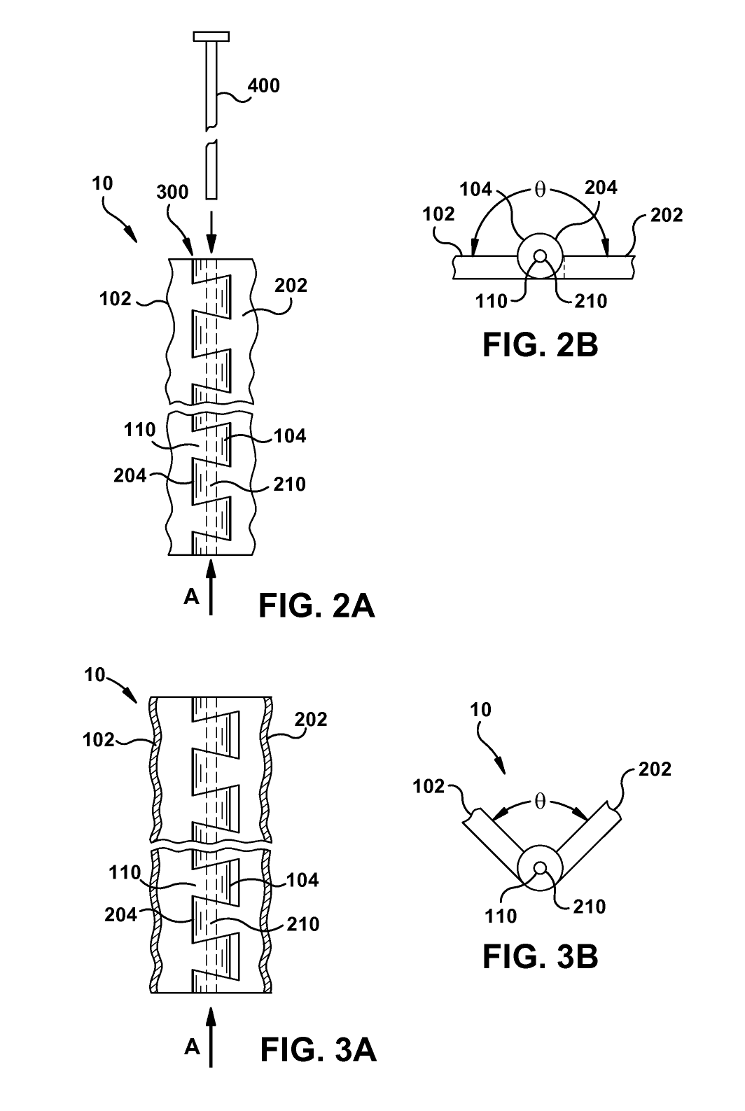

As will be described below with reference to FIGS. 2A and 2B, the first fingers 104 are aligned with the second openings 206 such that when the first part 100 and the second part 200 mate, the second openings 206 receive the first fingers 104. Similarly, the second fingers 204 are aligned with the first openings 106 such that when the first part 100 and the second part 200 mate, the first openings 106 receive the second fingers 204.

Referring to FIG. 1B, both the first and second fingers 104, 204 have a circular cross section. The circular cross section facilitates the rotation of the hinge assembly 10. A first hole 110 is defined through each of the first fingers 104 in a length or longitudinal direction and a second hole 210 is defined through each of the second fingers 204 in a length or longitudinal direction. When the hinge assembly is in an assembled state, described below, the first holes 110 and the second holes 210 are aligned. Thus, an optional locking pin 400 (shown in FIG. 2A) can be inserted through the first and second holes 110, 210 to provide additional interlocking strength to the hinge assembly 10.

Referring to FIGS. 2A and 2B, FIG. 2A is a top view of the hinge assembly 10 and FIG. 2B is a side view taken in the direction of the arrow A shown in FIG. 2A. FIGS. 2A and 2B illustrate the hinge assembly 10 in the second stage of assembly, which is an assembled state. In the assembled state (stage 2), the first and second parts 100, 200 are mated, thus forming the interlocking joint 300. In the assembled state, the first part 100 and the second part 200 are in the same plane, thus forming an angle θ of approximately 180 degrees between the two parts 100, 200. Thus, although the interlocking joint 300 is formed and locked in a tensile direction, the interlocking joint 300 is not fully locked.

To mate the first and second parts 100, 200, the first and second parts 100, 200 are placed adjacent to each other such that the first and second fingers 104, 204 are aligned in a shear direction with the second and first openings 206, 106 respectively. The first and second parts 100, 200 are then pushed together such that the first and second openings 106, 206 receive the second and first fingers 204, 104 respectively. The first and second parts 100, 200 are now mated, thus forming the interlocking joint 300. This interlocking feature lends itself to the next action of rotation, which is to lock the first and second parts 100, 200 together, described further below.

As mentioned above, when the hinge assembly is in an assembled state, the first holes 110 and the second holes 210 are aligned. At this point in the assembly process, the optional pin 400 can be inserted through the first and second holes 110, 210 from either side of the hinge assembly 10 to provide additional interlocking strength to the hinge assembly 10. Although the optional pin 400 is not required, the pin 400 may be used in certain applications as needed.

Referring to FIGS. 3A and 3B, FIG. 3A is a top view of the hinge assembly 10 and FIG. 3B is a side view taken in the direction of the arrow A shown in FIG. 3A. FIGS. 3A and 3B illustrate the hinge assembly 10 in the third stage of assembly, which is the locked state. In the locked state (stage 3), the first and second parts 100, 200 are mated and rotated with respect to each other to an angle θ of approximately 90 degrees. Once the first and second parts 100, 200 are rotated, the interlocking joint 300 is formed and fully locked. The unique shape of the first and second fingers 104, 204 facilitates the interlocking feature of the hinge assembly 10. In other words, in order to separate the first part 100 from the second part 200 (or vice versa), the first and second parts 100, 200 are rotated back to approximately 180 degrees so that the first and second parts 100, 200 are in the same plane, as shown in FIG. 2B.

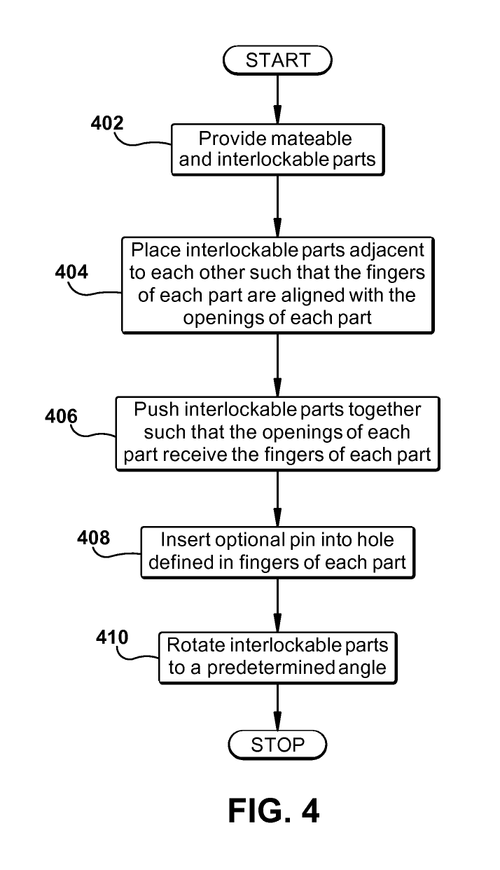

FIG. 4 is an illustration of an example methodology of interlocking materials in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, interlock-able pieces or parts comprising the first part 100 and the second part 200 are provided. As described above, the first and second fingers 104, 204 of the first and second parts 100, 200 are configured into a unique shape such that when interlocked and/or rotated, provides inherent retention.

At 304, the first and second parts 100, 200 are placed adjacent to each other such that the first and second fingers 104, 204 are aligned in a shear direction with the second and first openings 206, 106 respectively. At 306, the first and second parts 100, 200 are then pushed together such that the first and second openings 106, 206 receive the second and first fingers 204, 104 respectively. The first and second parts 100, 200 are now mated, thus forming the interlocking joint 300.

At 308, the optional locking pin 400 can be inserted to provide additional strength from separation. At 310, the first and second parts 100, 200 are rotated, as described above, to interlock the first and second parts 100, 200.

Once assembled and rotated to the proper angle, the hinge assembly 10 described above, is tightly “interlocked” in; tension, compression, shear, torsion (excluding the rotational locking twist direction of rotation), and cantilever forces (given sufficiently spaced, interlocking fingers) to resist/prevent movement between the first and second parts 100, 200.

It is to be understood that additional parts having both functioning and non-functioning fingers interacting at the interlocking joint can be also allowed as part of the function of the design/concept. These alternatives are to be included within the scope of the specification described herein.

It is to be further understood that the resultant interlocking joint is based on the material type, dimensions, and tolerance. Using acrylic-like material from rapid prototype samples that suggest materials with wood-like or similar properties of strength, stiffness, rigidity, etc., surface friction can easily be made to function well. The “locking angle of rotation” may also be varied, e.g., something less than (or greater than) ninety degrees to provide possible quicker engagement.

The overall result of this concept is a potentially very flexible, yet unique, buildable block system for adults and for many construction/home-use/assembly/design customization type products and product features. Thus, the overall concept has very broad application including, but not limited to furniture, construction, manufacturing plastics, wood products, structural elements (e.g., scafolds, fixturing, tube/pipe fittings, etc.) and many other mechanical structure items. In yet other aspects, it is contemplated that the features, functions and benefits of the innovation can be applied to molecular structure bonding (e.g., nano-technology). These and other applications of the technology are to be included within the scope of this disclosure without departing from the scope defined herein.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates an interlocked joint comprising:
a first member having a plurality of first fingers extending in an outward direction from a side of the first member and a plurality of first openings defined between each of the plurality of first fingers;
a second member having a plurality of second fingers extending in an outward direction from a side of the second member and a plurality of second openings defined between each of the plurality of second fingers;
wherein when the first member mates with the second member the plurality of first fingers are aligned with and engage the plurality of second openings and the plurality of second fingers are aligned with and engage the plurality of first openings such that the first member and the second member are interlocked and inseparable in a tensile direction.

2. The system of claim 1, wherein when the first member and the second member are rotated with respect to each other to a predetermined angle the first member and the second member are interlocked and inseparable in any direction.

3. The system of claim 1, wherein the plurality of first fingers and the plurality of second fingers have a trapezoidal shape, and wherein the plurality of first openings and the plurality of second openings have a shape configured to receive to the plurality of second fingers and the plurality of first fingers respectively.

4. The system of claim 1, wherein the plurality of first fingers have a circular cross section and include a first hole defined in the longitudinal direction, wherein the plurality of second fingers have a circular cross section and include a second hole defined in the longitudinal direction, wherein the first hole and the second hole are aligned when the first member mates with the second member.

5. The system of claim 4 further comprising a pin, wherein when the first member mates with the second member, the pin is inserted through the first hole defined in each of the plurality of first fingers and the second hole defined in each of the plurality of second fingers.

6. The system of claim 5, wherein the plurality of first fingers extend in an outward direction from a side or an edge of the first member, thus forming the plurality of first openings, and wherein the plurality of second fingers extend in an outward direction from the second member, thus forming the plurality of second openings.

7. The system of claim 6, wherein the first member and the second member are manufactured of plastic, metal or wood.

8. An interlocking joint hinge assembly comprising:
a first part having a plurality of first fingers and a plurality of first openings;
a second part having a plurality of second fingers and a plurality of second openings,
wherein when the first part mates with the second part the first fingers align with the second openings and the second fingers align with the first openings, and
wherein when the first part and second part are rotated with respect to each other to a predetermined angle the first part and the second part are interlocked and inseparable in any direction.

9. The assembly of claim 8, wherein the plurality of first fingers and the plurality of second fingers have a trapezoidal shape, and wherein the plurality of first openings and the plurality of second openings have a shape configured to receive to the plurality of second fingers and the plurality of first fingers respectively.

10. The assembly of claim 8, wherein the plurality of first fingers have a circular cross section and include a first hole defined in the longitudinal direction, wherein the plurality of second fingers have a circular cross section and include a second hole defined in the longitudinal direction, wherein the first hole and the second hole are aligned when the first part mates with the second part.

11. The assembly of claim 8 further comprising a pin, wherein when the first part mates with the second part, the pin is inserted through the first hole defined in each of the plurality of first fingers and the second hole defined in each of the plurality of second fingers.

12. The assembly of claim 11, wherein the first part includes a first plate and the second part includes a second plate.

13. The assembly of claim 12, wherein the plurality of first fingers extend in an outward direction from an edge of the first plate, thus forming the plurality of first openings, and wherein the plurality of second fingers extend in an outward direction from an edge of the second plate, thus forming the plurality of second openings.

14. The assembly of claim 13, wherein the first part and the second part are manufactured of plastic, metal or wood.

15. A method of interlocking two members comprising:
providing a first member having a plurality of first fingers and a plurality of first openings and a second member having a plurality of second fingers and a plurality of second openings;
placing the first part adjacent to the second part such that the plurality of first fingers align with the plurality of second openings and the plurality of second fingers align with the plurality of first openings;
pushing the first part and the second part together such that the plurality of first openings receive the plurality of second fingers and the plurality of second openings receive the plurality of first fingers; and
rotating the first part and the second part with respect to each other to a predetermined angle.

16. The method of claim 15, wherein prior to rotating the first part and the second part with respect to each other to a predetermined angle, the method further comprising inserting a pin through a first hole defined in the plurality of first fingers and a second hole defined in the plurality of second fingers.

17. The method of claim 16, wherein the plurality of first fingers and the plurality of second fingers have a trapezoidal shape and a circular cross section.

18. The method of claim 17, wherein the first part includes a first plate and the second part includes a second plate.

19. The method of claim 18, wherein the plurality of first fingers extend in an outward direction from an edge of the first plate, thus forming the first openings, and wherein the plurality of second fingers extend in an outward direction from an edge of the second plate, thus forming the second openings.

20. The method of claim 19, wherein the predetermined angle is approximately 90 degrees.
